(19) United States
(12) Patent Application Publication
(10) Pub. No.: US 2007/0119774 A1
(43) Pub. Date: May 31, 2007

(54) Process for removing microbubbles from a liquid

(76) Inventors: Larry Yen, Andover, MA (US); Jay Duffner, Shirley, MA (US); Saksatha Ly, Lexington, MA (US)

Correspondence Address: MYKROLIS CORPORATION, 129 CONCORD ROAD, BILLERICA, MA, 01821-4600, US

(21) Appl. No.: 10/585,960

(22) PCT Filed: Jan. 11, 2005
(86) PCT No.: PCT/US05/00753

§ 371 Date: Jul. 13, 2006

Related U.S. Application Data
(60) Provisional application No. 60/539,409, filed on Jan. 27, 2004.

(51) Int. Cl. B01D 39/14

(52) U.S. Cl. 210/500.1

(57) ABSTRACT

A process is provided for removing microbubbles from a liquid by filtration with a composite porous membrane which is formed from a porous polymeric membrane having an average pore size between about 0.01 and 0.03 microns on which is directly coated a cross-linked polymer derived from N,N-methylenebisacrylamide (MBAM) optionally containing dimethylacrylamide (DMAM).

### CROSS REFERENCE TO RELATED APPLICATIONS

This application claims the benefit of and priority to U.S. Provisional Application Ser. No. 60/539,409 filed Jan. 27, 2004 the contents of which are incorporated herein by reference in their entirety.

### BACKGROUND AND SUMMARY

Top antireflective coating (TARC) is used in photolithography to attenuate photons reflected from a resist/air interface during exposure of the resist to a light pattern. The thin TARC/film alters the phase of photons reflected from the TARC/air interface by 180° relative to the photon reflection from the TARC/resist interface. These light waves destructively interfere, reducing the energy from this reflection and thus reducing variation in light intensity through the thickness of the resist. Line width resolution can be improved and undesirable steps in the resist sidewall can be reduced by application of a TARC film.

TARC is dispensed onto a spinning wafer after deposition of photoresist or soft bake. The TARC fluid is an acidic aqueous preparation of a fluorinated surfactant sometimes accompanied by an organic polymer. The surfactant lowers the surface tension of the TARC fluid, giving the coating better uniformity, but contributes to the severity of microbubble defects. Microbubbles comprising stable gas bubbles generally less than 10 μm in diameter, are the major contributor to defects in TARC films. Microbubbles in TARC solutions lead to defects in TARC films such as those deposited on a photoresist film utilized to form electrically conductive pathways on electronic components.

A surfactant in a liquid forms a skin around a microbubble at the gas/liquid interface. The surfactant can change the surface tension at the gas/liquid interface by moving between the bulk liquid and the gas/liquid interface. Variable surface tension allows microbubbles to change radius which prevents microbubbles from collapsing under shear stress and pressure fluctuations. In addition, the surfactant skin acts as a barrier to mass transfer of gas from the bubble to the surrounding liquid so that pressurization of the liquid may not result in re-dissolving of gas into the surrounding liquid. The ability to change shape and the reduced rate of gas dissolution allow surfactant-stabilized microbubbles to persist once they form in solution.

The distinction between a bubble and a microbubble is based on size. Bubbles and microbubbles are less dense than the liquid in which they exist and, given time, will rise to the surface of the liquid. The rate at which a bubble will rise is dependent on the liquid's viscosity and the bubbles diameter. This phenomenon is expressed by applying Stoke's law for gasses in water. Table 1 gives the rising velocity in water for a bubble of given diameter. A 1 μm bubble will take nearly 7 days to rise from the bottom to the top of a 30 cm tall container and a 100 μtm bubble will rise to the same surface in only 55 seconds.

While bubbles will rise to the liquid/air interface in the matter of minutes, microbubbles will persist in liquids for hours or days. In addition, bubbles and microbubbles in TARC solutions containing surfactant will take longer to rise than in pure fluids of equivalent viscosity due to drag forces created by the surfactant coating on the microbubbles.

TABLE 1
Rising velocity of bubbles in water at 20° C.
according to Stokes's Law.

| | |
|---|---|
| | Rising Velocity |
| Bubble Diameter | cm/sec |

| | | |
|---|---|---|
| 0.1 | um | 5.437E−07 |
| 1 | um | 5.437E−05 |
| 10 | um | 0.00544 |
| 100 | um | 0.544 |
| 1,000 | um | 54.37 |

Bubbles and microbubbles are formed in liquids when the solubility of dissolved gasses decreases. Pressure fluctuations, such as those created during fluid pumping, can cause the formation of bubbles and microbubbles by several different mechanisms. Homogeneous nucleation, heterogeneous nucleation and cavitation are proposed mechanisms in the literature for the formation of bubbles and microbubbles. Homogeneous nucleation results in the formation of microbubbles throughout a liquid when gas molecules form clusters and grow to a defined size. This phenomenon occurs when supersaturated dissolved gas in a liquid suddenly becomes insoluble, for example, by a reduction in pressure. Homogeneous nucleation is rare and is not a likely mechanism for bubble and microbubble formation in TARC. Heterogeneous nucleation is defined as bubble growth that occurs on hydrophobic surfaces. Hydrophobic surfaces or particles act as catalysts for bubble and microbubble formation when gas solubility in a liquid is reduced. The third mechanism, cavitation, is characterized by bubble and microbubbles formation at nucleation sites caused by a sudden reduction in pressure of a moving fluid. Both heterogeneous nucleation and cavitation are the likely mechanisms for bubble and microbubbles formation in TARC.

Since microbubbles have very small rising velocities, they cannot be adequately removed by giving the microbubble time to rise to the top of a container or chamber. Also, surfactant coated microbubbles resist dissolution when under pressure due to slow mass transfer of gas to the liquid and the ability of these microbubbles to change shape.

Accordingly, it would be desirable to provide a process for removing microbubbles from a liquid, particularly a surfactant-containing liquid which does not depend upon microbubble movement to a liquid/gas interface. In addition, it would be desirable to provide such a process which removes a substantial amount of microbubbles from the liquid.

This invention is based upon the discovery that porous membrane substrates having their surface modified with amide-containing monomers are particularly suitable for filtering liquids including acidic TARC surfactant-containing solutions to remove microbubbles therefrom. It is preferred to utilize porous membrane substrates that are resistant to degradation by acidic liquid solutions. It has been found that surface modified membranes having a hydrophilic modified surface are particularly useful for removing microbubbles from acidic solutions and are mechanically stable in such solutions.

The present invention utilizes a surface modified membrane formed of a porous membrane substrate having an average pore size between about 0.01 microns and about 0.03 microns having its surface modified with amide groups. The amide groups are derived from polymerizable, cross-linkable amide containing monomers comprising either N,N-methylene bisacrylamide (MBAM) (cross-linker) alone or N,N-methylenebisacrylamide mixed with dimethylacrylamide (DMAM) (monomer) at a weight ratio of MBAM/DMAM of between about 1:0 to about 1:4, preferably between about 1:1 to about 1:3. Each repeating molecular unit of polymerized MBAM contains two amide groups while each repeating molecular unit of polymerized DMAM contains one amide group. By varying the weight ratio of MBAM/DMAM, one can control the concentration of amide moiety positioned on a polymer backbone. Thus, the relative polar interaction and non-polar interaction characteristics of a membrane can be controlled and optimized for a given photoresist composition. The MBAM/DMAM cross-linker/monomer composition is deposited on the surface of the substrate porous membrane with a polymerization initiator and then is polymerized and cross-linked in situ on the substrate. As a result, the entire surface including the pore surfaces is modified with the cross-linked amide composition to form a porous membrane having a desired ratio of amide to methylene moieties.

It also has been found that the surface modified porous membrane compositions of this invention are more effective in removing microbubbles, from a liquid composition particularly an acidic aqueous solution containing a polymer such as a fluoropolymer and a surfactant such as a fluorinated surfactant than is the unmodified porous membrane substrate even when the unmodified porous membrane substrate has an average pore size which is smaller than the average pore size of the surface modified porous membrane utilized in this invention. It has been found that these surface modified membranes are more stable against degradation by acidic solution as compared to polyamide membranes, such as Nylon 66.

### DETAILED DESCRIPTION

A representative TARC composition which is filtered with the surface modified porous membrane of this invention comprises an acidic aqueous preparation of a fluorinated surfactant sometimes accompanied by an organic polymer with a pH between about 2 and 3.

In accordance with this invention a polymeric porous membrane having the desired resistance against degradation by an aqueous solution such as a TARC solution is directly coated throughout its entire surface with a polymerized cross-linked amide containing monomer composition. The monomer is deposited on the surfaces of the polymeric porous membrane substrate by graft polymerization and/or by deposition of the cross-linked monomer. The desired deposition of the cross-linked monomer onto the polymeric porous membrane substrate is effected as a direct coating and does not require or utilize an intermediate binding chemical moiety.

The term “polymeric porous membrane substrate” as used herein is meant to include polymeric compositions formed from one or more monomers. Representative suitable polymers forming the porous membrane include polyolefins such as polyethylene, polypropylene, polymethylpentene, high density polyethylene, ultrahigh molecular weigh polyethylene (UPE) such as those prepared by the process of U.S. Pat. Nos. 4,778,601 and 4,828,772 which are incorporated herein by reference and the like; polystyrene or substituted polystyrenes; fluorinated polymers including poly(tetrafluoroethylene), polyvinylidene fluoride or the like; polyesters including polyethylene terephthalate, polybutylene terephthalate or the like; polyacrylates; polycarbonates; vinyl polymers, such as poly vinyl chloride and polyacrylonitriles. Copolymers also can be unemployed such as copolymers of butadiene and styrene, fluorinated ethylene-propylene copolymer, ethylene-chlorotrifluoroethylene copolymer or the like. Generally the polymeric porous membrane substrate has an average pore size between about 0.005 and 0.05 microns and more usually between about 0.01 and 0.03 microns.

The polymerization and cross-linking of the polymerizable monomer to the porous membrane by grafting and/or deposition must be effected so that the surfaces of the porous membrane including the inner surfaces of the pores are coated with a cross-linked/grafted polymer. Preferably, the surfaces of the porous membrane are entirely coated. Therefore, in a first step, the porous membrane is washed with a solvent composition that does not swell or dissolve the porous membrane and which wets the surfaces of the pores such as a mixture of water and an organic solvent. Suitable water-solvent compositions for this purpose include methanol/water, ethanol/water, acetone/water, tetrahydrofuran/water or the like. The purpose of this wetting step is to assure that the cross-linker/monomer composition subsequently contacted with the porous membrane wets the entire surface of the porous membrane. This preliminary wetting step can be eliminated when the reagent bath described below itself functions to wet the entire surface of the porous membrane. This can be affected when the reagent both contains a high concentration of organic reactants, for example 15% by weight or higher. In any event, all that is required is that the entire porous surface be wet so that the polymerizable monomer wets the entire surface of the porous membrane.

Suitable polymerizable cross-linker/monomer compositions include MBAM either alone or mixed with DMAM at a weight ratio of MBAM/DMAM between about 1:0 to about 1:4, preferably between about 1:1 to about 1:3. An amide density (AD) value for a microporous membrane which contains amide functionalized polymers on its surfaces can be defined as: AD=(Number of amide with substitute or non substitute groups in polymer repeat unit/molecular weight of polymer repeat unit). The (AD) values for surface modified membrane of this invention with MBAM/DMAM weight ratios of 1:0 and 1:4 are 0.013 and 0.010 respectively. For comparison, the (AD) for a membrane made from Nylon 66 polymer is 0.009.

Suitable initiators and cross-linking agents for the monomers set forth above are well known in the art. The monomer, polymerization initiator and cross-linking agent are contacted with the porous membrane as a mixture in a solvent which is compatible with the three reactants and the porous membrane so that the desired free radical polymerization and cross-linking is achieved without the formation of a significant amount of slowly extractable by-products and without the formation of colored products. If readily extractable by-products are formed, these can be removed by conducting a washing step in a suitable solvent subsequent to the coating step.

The particular solvent employed for the polymerizable monomer, polymerization initiator and cross-linking agent will depend upon the particular reactants employed and upon the particular polymer utilized to form the porous membrane. All that is necessary is that the reactants dissolve in the solvent and are capable of being reacted by free radical initiation in the solvent system and that the solvent does not attack the porous membrane substrate. Thus, the particular solvent system used will depend upon the reactants and porous membranes employed. Representative suitable solvents include water or organic solvents such as alcohols, esters, acetone or compatible aqueous mixtures thereof.

Generally, the polymerizable cross-linker/monomer mixture is present at a total concentration between about 1% and about 20%, preferably between about 3% and about 9% based upon the weight of the reactant solution. The polymerization initiator is present in an amount of between about 0.25% and about 2.5% by weight, preferably between 0.75% and 1.75% by weight based upon the total weight of the polymerizable cross-linker/monomer mixture.

Any conventional energy source for initiating free radical polymerization can be employed such as heating, ultraviolet light, gamma radiation, electron beam radiation or the like. For example, when free radical polymerization is initiated by heating, the reactant solution and the porous membrane are heated to a temperature at least about 60° C. and up to the temperature at which undesirable bulk polymerization occurs in solution or at which the solvent begins to boil. For example, generally suitable temperatures when utilizing an aqueous solvent system between about 80° C. and about 95° C., preferably between about 88° C. and about 92° C. The polymerization reaction should be effected for a time to assure that the entire exposed surface of the porous membrane is coated with the deposited polymer composition but without plugging of the pores in the membrane. Generally, suitable reaction times are between about 0.1 and about 30 minutes, preferably between about 1 and about 2 minutes. Reaction can be effected while the porous membrane is immersed in solution. However, this will result in the polymerization of the monomer throughout the solution. It is preferred to saturate the porous membrane with the reactant solution and to effect reaction outside of the solution so that monomer is not wasted. Thus, the reaction can be conducted batch wise or continuously. When operating as a continuous process, a sheet of porous membrane is saturated with the reactant solution and then transferred to a reaction zone where it is exposed to energy to effect the polymerization reaction.

A comparison of mean isopropyl alcohol (IPA) bubble points (or mean IPA flow pore pressure as described in ASTM method F316-80) of the surface modified porous membranes utilized in this invention with Dev membrane is as follows: Optimizer Dev (catalog number CWUZ16EL1, Mykrolis Corporation)=50 psi, UPE(0.03 microns) DMAM/MBAM 1:1=85 psi. The surface modified membranes utilized in this invention have an IPA bubble point greater than 50 psi. IPA bubble point provides a good measure of the capacity of a porous membrane to retain particles by size exclusion removal.

This invention relates to a process for removing microbubbles from a liquid. More particularly, this invention relates to a process for removing microbubbles from a liquid by filtration.

The following examples illustrate the present invention and are not intended to limit the same.

### EXAMPLE 1

Several filter membranes were chosen for study based on knowledge of bubble formation mechanisms and surfactant stabilized microbubble behavior. Membrane candidates with a range of particle retention (from 0.02 μm to 0.1 μm) and surface energy (hydrophobic or hydrophilic) were tested for their ability to lower microbubble level in a TARC fluid. Two sets of testing were performed to determine how retention rating and surface energy affect microbubble level in the liquid.

Laboratory experiments were conducted with an IntelliGen® 2 dispense system available from Mykrolis Corporation, Billerica, Mass., USA and AZ Aquatar® TARC available from Clariant Corporation, Somerville, N.J., USA. A Particle Measuring Systems Liquilaz® SO2 optical particle counter available from Particle Measuring Systems (PMS) Corporation, Boulder, Colo., USA was installed on the dispense line The filters were primed with the TARC and the dispense procedure was continually performed until particle counts leveled off.

Particle count results showing a reduction of microbubble level with more retentive filtration media. Particle counts include all counts sized >0.2 μm. All membranes tested are flat sheet pleated membranes with the exception of 0.1 micron hollow fiber UPE. The data shows that filtration media retention efficiency has a large effect on microbubble level at steady state. The lowest level of microbubbles was provided by the 0.02 μm UPE hydrophilic membrane.

The data shows that most “particles” being detected by the optical particle counter are bubbles and not particles because the particle distribution plotted on log-log axes is not linear. Cumulative particle counts are plotted vs. particle size. When only particles are present, cumulative particle count data forms a linear curve with a slope of −2 to −3.5 when plotted on log-log axes. Particle count data showing a knee and/or a lower slope indicates the presence of microbubbles. The data collected in this experiment has both characteristics.

A re-circulation test stand was built to measure the microbubble level downstream of several types of filtration media after fluid has been left stagnant for a period of time. A hydrophobic (low surface energy) UPE filter (LHVD) and a hydrophilic (high surface energy) UPE (PCM) filter were installed sequentially in the “Sample Filter” location. The PCM surface is modified with a weight ratio of MBAM:DMAM of 1:0 prepared with 0.02 μm UPE porous membrane substrate as described above. A Rion KL-20 optical particle counter (OPC) available from Rion Corporation, Ltd., Tokyo, Japan was installed downstream of the test filter to detect microbubbles. The pump was run until particle counts leveled off, at which point the pump was stopped. After two hours, the pump was restarted and the particle count downstream of the filter was measured.

The heterogeneous nucleation mechanism of bubble formation shows that hydrophobic materials will act as nucleation sites for microbubble formation. The data show a large spike in particle counts for the hydrophobic filter after the resumption of flow. This spike is much more muted for the hydrophilic filter and particle counts quickly drop to low levels.

The 0.02 μm rated hydrophilic UPE membrane provided the lowest level of microbubbles at steady state and after a stoppage of flow. This membrane was incorporated into the 0.02 μm IMPACT Plus PCM filtration device.

The filter types tested were installed at a semiconductor manufacturing line in an effort to lower defects in top antireflective coating films. The experiment's goal was to find the type of filter that provided the lowest level of defects and to determine if lowered wafer-level defects would correlate with lower microbubble level as measured by optical particle counter.

The filters were installed in an RDS dispense system using AZ Aquatar TARC. The filters were installed and primed. TARC coated wafers were analyzed for defects with a KLA-Tencor AIT 2 available from KLA-Tencor Corporation, San Jose, Calif., USA. The defect reduction trend revealed that filtration media retention efficiency and surface energy had a dramatic effect on wafer-level defects. The 0.02 μm PCM membrane in the IMPACT Plus device was able to satisfactorily lower defect level in the TARC film. Use of the filter resulted in: a 57% reduction in defects compared to 0.04 μm nylon membrane; an 85% reduction in defects compared to 0.1 μm nylon membrane; an 88% reduction in defects compared to 0.1 μm hollow fiber UPE (unmodified).

In a second semiconductor manufacturing line, a 0.05 μm IMPACT Plus LHVD (unmodified UPE) was tested in parallel with a 0.02 μm IMPACT Plus PCM porous membrane, a semiconductor wafer processing facility with NFC 540 TARC available from Japanese Scientific Rubber Corp. (JSR) of Sunnyvale, Calif., U.S.A. Wafer level defects were measured with a KLA-Tencor SPI available from KLA-Tencor Corporation, San Jose, Calif., USA. The 0.02 μtm IMPACT Plus PCM (surface modified) proved to be an improvement over 0.05 μm IMPACT LHVD in two ways. The PCM filter reduced defect counts by 50% and eliminated the occurrence of random spikes in defect level. Table 2 contains the data from this evaluation.

TABLE 2
Wafer level defect data in TARC film as measured by SP1.

| Filter Name | Average Defect Level | Periodic Spike |
|---|---|---|
| 0.05 μm IMPACT LHVD | 60-70 defects/wafer | 250 defects/wafer |
| 0.02 μm IMPACT Plus | 30-40 defects/wafer | none |
| PCM | | |

This data reveal the importance of selecting a hydrophilic, highly retentive filtration media for TARC filtration. The 0.02 μm IMPACT Plus PCM provides the lowest level of on-wafer defects and prevented the occurrence of random spikes in defect level in top antireflective coatings.

### EXAMPLE 2

A surface modified UPE membrane is prepared from a hydrophobic microporous UPE membrane manufactured by Mykrolis Corporation (catalog number CWAY01). It has a rated average pore size of 0.03 μm and an average thickness of 42 μm.

The hydrophobic 0.03 μm UPE membrane is unwound and passed through a membrane surface treatment to sequentially pre-wet with isopropyl alcohol (IPA) to prevent air locking in the pore, and then 20 wt. % hexylene glycol and 80% water solution.

After soaking in the hexylene glycol/water solution, the membrane is immersed into the polymerizable monomer and cross-linker mixture solution containing 0.3.% Irgacure 2959 (Ciba Specialty Chemical AG), 10% acetone, 3.5% N,N-methylenebisacrylamide, 86.2% water, all by weight. The monomer wet membrane is sandwiched between sheets of polyethylene (PE) film, and exposed to UV lamp “Fusion H bulb type” for each side of the membrane with the total of 4 UV lamps, followed by water rinsed, dried, and wound up on the core.

The resulting membrane is tested for wettability with water, water flow rate, mean isopropyl alcohol (IPA) bubble point and membrane thickness. Results are: Water wet time (sec): 0.1 sec; Water flow rate (ml/min/cm2) is 1.2 @ 13.5 psi differential pressure and 21° C.; Thickness is 42 μm; Mean IPA Bubble Point (ASTM method F316-80) is 85 psi.

### EXAMPLE 3

Example 2 was repeated by using a monomer solution containing 4% MBAM, 4% DMAM, 10% acetone, Irgacure 0.75%. The resultant membrane has the following properties:

Water wet time (sec): 0.1 sec; Water flow rate (ml/min/cm2) is 1.2 @ 13.5 psi differential pressure and 21° C.; Thickness is 42 μm; Mean 1 IPA Bubble Point (ASTM method F316-80) is 86 psi

### EXAMPLE 4

This example provides a comparison of the composite porous membranes of this invention with a 0.04 micron porous Nylon 6,6 membrane and a composite membrane having a substrate comprising 0.05 microns UPE (Dev).

TABLE 3

| | | Ion Exchange | Ion Exchange |
|---|---|---|---|
| | | Capacity | Capacity |
| | Monomer to | (IEC) *** Cation | (IEC) *** Anion |
| | Xlinker | Exchange | Exchange |
| Membrane | (Wt. Ratio) | (nmol/cm²) | (nmol/cm²) |
| DEV | 3 to 1 | 18.5 | 20.2 |
| Example 2 | 0 to 1 | 17.8 | 10.6 |
| Example 3 | 1 to 1 | 17.7 | 13.1 |
| 0.04 μm Nylon 66 | N/A | 18.8 | 14.4 |
| Pall Corporation | | | |
| Catlalog No. | | | |
| MCD 924UNDEJ | | | |

Note:
the cation and anion exchange capacity (iec) are measured by a titration method using a METTLER TOLEDO-DL58 Autotitrator. Sodium hydroxide and silver nitrate solutions are used as reagents to determine the cation and anion iec respectively.

TABLE 4

| | Hydrocarbon X to Amide | Membrane wet time |
|---|---|---|
| | —(CO—NR′)— ratio in | with 10 wt. % |
| | Surface Polymer Repeat | Methanol/Water |
| Membrane | Unit | Solution |
| DEV | 2.9:1 | <1 sec |
| Example 2 | 2.5:1 | <1 sec |
| Example 3 | 2.8:1 | <1 sec |
| 0.04 μm Nylon 66 | 5.0:1 | <1 sec |

X = —CH₂— or CHR— or —CH₃
R′H or CH₃

### EXAMPLE 5

This example provides a comparison of the composite porous membrane of this invention with a 0.04 micron porous Nylon 66 membrane and a composite membrane having a substrate comprising 0.05 microns UPE (Dev).

TABLE 5

| | | Ion Exchange | Ion Exchange |
|---|---|---|---|
| | | Capacity | Capacity |
| | Monomer | (IEC) *** Cation | (IEC) *** Anion |
| | to Xlinker | Exchange | Exchange |
| Membrane | (Wt. Ratio) | (nmol/cm²) | (nmol/cm²) |
| DEV | 3 to 1 | 18.5 | 20.2 |
| Example 2 | 0 to 1 | 17.8 | 10.6 |
| Example 3 | 1 to 1 | 17.7 | 13.1 |
| 0.04 μm Nylon 66 | N/A | 18.8 | 14.4 |
| Pall Corporation | | | |
| Catlalog No. | | | |
| MCD 924UNDEJ | | | |

Note:
the cation and anion exchange capacity (iec) are measured by a titration method using a METTLER TOLEDO-DL58 Autotitrator. Sodium hydroxide and silver nitrate solutions are used as reagents to determine the cation and anion iec respectively.

TABLE 6

| | Hydrocarbon X to Amide | Membrane wet time |
|---|---|---|
| | —(CO—MR′)— ratio in | with 10 wt. % |
| | Surface Polymer Repeat | Methanol/Water |
| Membrane | Unit | Solution |
| DEV | 2.9:1 | <1 sec |
| Example 2 | 2.5:1 | <1 sec |
| Example 3 | 2.8:1 | <1 sec |
| 0.04 μm Nylon 66 | 5.0:1 | <1 sec |

X = —CH₂— or CHR— or —CH₃
R′H or CH₃

What is claimed is:

1. An article comprising:
a porous membrane, the membrane surfaces modified to be hydrophilic by polymerization of one or more monomers deposited on the membrane surface, the relative polar interaction and non-polar interactions characteristics of the surface modified membrane removes microbubbles from a liquid in contact with the modified membrane.

2. The article of claim 1 where the surface modified membranes are mechanically stable against degradation.

3. The article of claim 1 where the relative polar and non-polar interaction characteristics of the membrane are controlled by the concentration of amide and methylene moieties in the modified surface.

4. The article of claim 1 where the modified membrane is incorporated into a filtration device.

5. A composite porous membrane which comprises:
a polymeric porous membrane substrate having pores between about 0.005 and about 0.05 microns, the substrate having surfaces modified with amide groups, the amide groups derived from a polymerizable composition comprising one or more amide monomers deposited on surfaces of the porous substrate and polymerized in situ on the surfaces of the porous substrate.

6. The composite porous membrane of claim 5 where the polymerizable composition includes N,N-methylbisacrylamide (MBAM), dimethylacrylamide (DMAM), or a combination of these with MBAM/DMAM weight ratios of between about 1:0 to about 1:4.

7. The composite porous membrane of claim 5 where the polymerizable composition includes an initiator.

8. The composite porous membrane of claim 5 wherein the substrate is ultrahigh molecular weight polyethylene.

9. The composite porous membrane of claim 5 wherein the substrate is polytetrafluoroethylene.

10. The composite porous membrane of claim 5 having a mean IPA bubble point greater than 50 psi.

11. The composite porous membrane of claim 5 where the ratio of amide to methylene groups controls the polar and non-polar interaction characteristics of the membrane.

12. A process for removing microbubbles from a liquid which comprises filtering said liquid with a composite porous membrane substrate having an average pore size between about 0.01 and 0.03 microns formed of a first polymer, said substrate being directly coated on its entire surface with a cross-linked second polymer formed from a monomer polymerized in situ with a free radical initiator and monomer composition comprising N,N-methylbisacrylamide (MBAM) optionally admixed with dimethylacrylamide (DMAM), said monomer composition being cross-linked in situ on said substrate, said composite porous membrane having essentially the same porous configuration as said porous membrane substrate.

13. The process of claim 12 wherein the first polymer is ultrahigh molecular weight polyethylene.

14. The process of claim 12 wherein the first polymer is polytetrafluoroethylene.

15. The process of claims 12 wherein said liquid is an acidic top antireflective coating.

16. The process of claims 12 wherein said liquid contains a surfactant.

17. The process of claim 16 wherein said liquid contains a fluoropolymer.

18. The process of claim 16 wherein said liquid contains a fluoropolymer and a surfactant.

19. The process of claim 16 wherein said surfactant is a fluorinated surfactant.

20. The process of claim 18 wherein said surfactant is a fluorinated surfactant.

21. A process for removing microbubbles from a liquid comprising: filtering the liquid with a porous membrane having a ratio of amide to methylene groups that controls the polar and non-polar interaction characteristics of the membrane.

22. The process of claim 21 further comprising the step of dispensing the liquid onto a spinning wafer.
